(19) United States
(12) Patent Application Publication
(10) Pub. No.: US 2004/0155210 A1
(43) Pub. Date: Aug. 12, 2004

(54) Instrument mounting apparatus for a fluid control valve

(76) Inventors: William E. Wears, Marshalltown, IA (US); Lynn D. Mahncke, Marshalltown, IA (US); David G. Halm, Haverhill, IA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/360,292

(22) Filed: Feb. 7, 2003

(51) Int. Cl. F16K 31/143

(52) U.S. Cl. 251/12; 251/63.5

(57) ABSTRACT

A yoke member for a fluid control valve is provided. The yoke member includes a plurality of passages for connecting an air supply line from a control instrument associated with the actuator to the actuator and a plurality of bores for directly attaching the control instrument to the yoke member. The yoke member may include symmetrically disposed passages so that the instrument may be mounted to either side of the yoke member. An adapter block may be used to connect the yoke member to a new NAMUR standard mounting pad.

This invention relates to fluid control valves, used to control the flow of liquids and/or gases, and in particular to apparatus for mounting instruments to control valves.

### BACKGROUND OF THE INVENTION

Fluid control valves, such as, for example, stem valves, typically include a valve body containing a valve seat, a valve plug attached to a movable valve stem, and an actuator mechanism for moving the valve plug via the valve stem. The actuator mechanism may include a frame or yoke member serving as a structural connection between the valve body and portions of the actuator mechanism, such as, for example, an actuator housing. Typically, an instrument or controller is attached to the yoke member, such as an instrument for providing an air signal to a portion of the actuator mechanism, such as, for example, a diaphragm or piston within the actuator housing. Often, such instruments or controllers (as well as possibly one or more optional accessories that use pressurized air) are connected to the yoke member with a separate bracket and/or external tubing to connect air passages within the instrument to air passages within the actuator.

It is desirable to eliminate some or all of such brackets and/or external tubing, in order to reduce the complexity and number of components of the fluid control valve. Accordingly, it is desirable to provide a yoke for a control valve that reduces the usual need for external tubing and/or brackets for mounting instruments to the fluid control valve.

### SUMMARY OF THE INVENTION

A yoke member is provided for a control valve having a movable member and an actuator operatively connected to the movable member. The yoke member includes a plurality of air passages for connecting an air supply line from a control instrument associated with the actuator to the actuator; and a plurality of bores for directly attaching the control instrument to the yoke member.

### BRIEF DESCRIPTION OF THE DRAWINGS

The features of this invention which are believed to be novel are set forth with particularity in the appended claims. The invention may be best understood by reference to the following description taken in conjunction with the accompanying drawings, in which like reference numerals identified like elements in the several figures and in which:

FIG. 1 is a sectional elevational view illustrating a fluid control valve having a yoke in accordance with the invention;

FIG. 2 is a perspective view of the yoke of the control valve of FIG. 1;

FIG. 3 is a perspective view of an alternative embodiment of the yoke;

FIG. 4 is a perspective view of a yoke having a side-mounted hand wheel with a fail open configuration attached thereto;

FIG. 5 is a view similar to view FIG. 4 showing a side-mounted hand wheel having a fail close configuration mounted to a yoke.

FIG. 6 is a perspective view of a yoke having a pressure regulator mounted thereto;

FIG. 7 is a perspective view of a yoke having an old NAMUR standard instrument mounted to a side rib thereof;

FIG. 8 is a perspective view of an alternative embodiment of the yoke having an adaptor block mounted thereto for providing a new NAMUR standard instrument interface; and

FIG. 9 is a perspective view of a fluid control valve having an instrument attached to both legs of a yoke.

### DETAILED DESCRIPTION

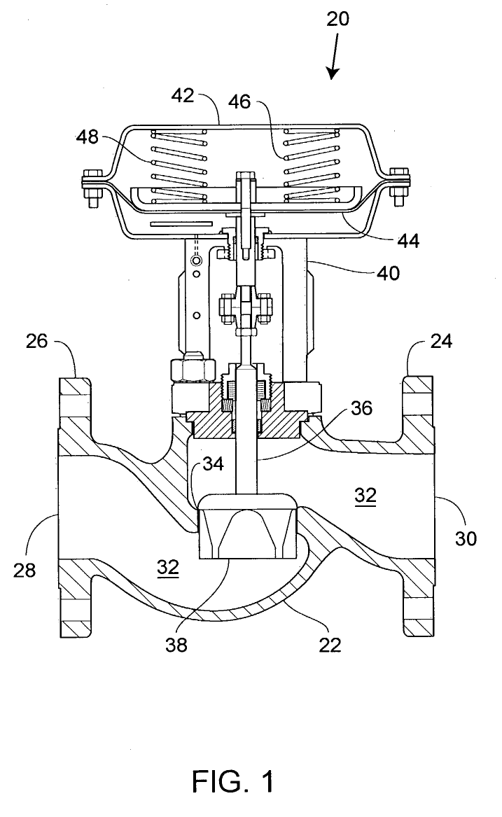

FIG. 1 shows a fluid control valve, generally indicated at 20 having a valve body 22 with opposite mounting flanges 24, 26 for mounting the fluid control valve 20, for instance, in a pipeline system. The valve body 22 also includes a fluid inlet 28 and a fluid outlet 30 with a passageway 32 communicating therebetween.

A valve seat 34 is provided in the passageway for controlling the fluid flow through the fluid control valve 20 in response to the position of a valve operating member such as a valve stem 36 having a valve plug 38 at one end for sealing engagement with the valve seat 34.

The fluid control valve 20 includes a yoke 40 for connecting the valve body 22 to an actuator housing 42 that contains a diaphragm 44 connected to the valve stem 36.

As will be recognized by one skilled in the art, the fluid valve control valve 20 depicted in FIG. 1 is a “fail close” valve, whereby the diaphragm 44 is biased downwardly by springs 46, 48. Thus, if air pressure is lost that would normally be used to provide air pressure below the diaphragm 44 in order to open the passage 32 to fluid flow, the springs 46 and 48 would bias the diaphragm 44 in the valve stem 36 downwardly as oriented in FIG. 1, thereby closing the passage 32 to fluid flow in the event of a loss of air pressure used to operate the fluid control valve 20.

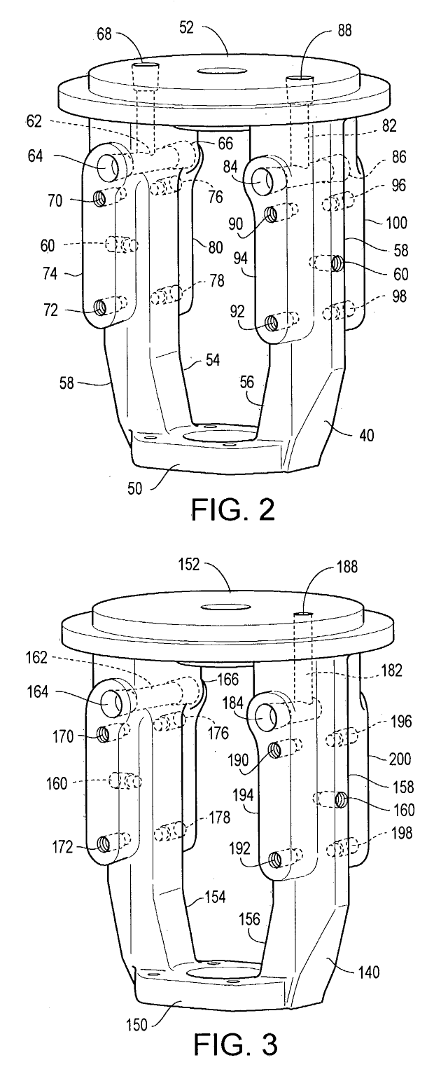

As shown in FIG. 2, the yoke 40 may include a lower mounting flange 50, an upper mounting flange 52, a first leg 54, and a second leg 56. Each leg 54, 56 may include a NAMUR rib 58 having a tapped (internally threaded) blind bore 60 therein that may be used to secure an instrument having an old NAMUR configuration to the yoke 40. The first leg 54 may include a T-shaped air passage 62 that connects a front instrument port 64, a rear instrument port 66, and a first actuator port 68, each of which may be tapped (internally threaded) to simplify connection of tubing or a plug to each of the ports 64, 66, and 68. The first leg 54 may further include tapped (internally threaded) blind bores 70 and 72 disposed on a forward side 74 of the leg 54, and tapped (internally threaded) blind bores 76 and 78 disposed on a rearward side 80 of leg 54.

Similarly, the second leg 56 includes a T-shaped air passage 82 connecting a front instrument port 84, a rear instrument port 86, and a second actuator port 88, each of which may be tapped (internally threaded). The second leg 56 further includes tapped (internally threaded) blind bores 90 and 92 on a forward side 94 of the second leg 56, as well as tapped (internally threaded) blind bores 96 and 98 on a rearward side 100 thereof.

Due to the symmetric configuration of the yoke 40, a great deal of flexibility is provided for the mounting of instruments and accessories to the yoke 40. For example, for a configuration in which air supply is to be provided below the diaphragm 44 of the fluid control valve 20 without the use of accessories, the air may be channeled directly from the back of the instrument into the second leg 56 of the yoke 40 through the front instrument port 84. The rear instrument port 86 on the second leg 56, as well as the front instrument port 64 and the rear instrument port 66, or the first actuator port 68 associated with the first leg 54 may all be plugged (e.g., with pipe plugs, not shown). Air may enter the actuator housing 42 through the second actuator port 88. In such a configuration, a vent port (not shown) may be provided on an upper portion of the actuator housing 42 to relieve pressure as the instrument feeds pressurized air into the actuator housing 42 below the diaphragm 44.

If the fluid control valve 20 is configured such that air supply is provided below the diaphragm 44 with accessories, the air may be channeled directly from the back of the instrument into the second leg 56 of the yoke 40 through the front instrument port 84, and the second actuator port 88 and the front instrument 64 on the first leg 54 may be plugged. Tubing (not shown) may be used to connect the rear instrument port 86 to the accessory, and from the accessory to the rear instrument port 66 of the first leg 54, and can then pass to the actuator housing 42 through the first actuator port 68. Again, a vent port (not shown) may be provided on a upper side of the actuator housing 42 to relieve pressure out as the instrument inputs air below the diaphragm 44.

If the fluid control valve 20 is configured such that air supply is provided above the diaphragm 44 without the use of accessories, the air may be channeled directly from the back of the instrument into the second leg 56 of the yoke 40 through the front instrument port 84. The second actuator port 88 as well as the front instrument port 64 on the first leg 54 may be plugged and tubing may be used to connect the rear instrument port 86 to the top of the actuator housing 42 to apply air pressure above the diaphragm 44. A vent may be provided at the rear instrument port 66 allowing the actuator housing 42 to vent out through the first actuator port 68 to the rear instrument port 66. If the use of an accessory is desired, the accessory may be placed in line between the rear instrument port 86 and the upper side of the actuator housing 42.

Due to the symmetry of the yoke 40, the instrument can be moved from the forward side 94 of the second yoke leg 56 to the rearward side 100 without disassembling the yoke 40 from the fluid control valve 20. However, the use of plugs in the various ports may require disassembly of the fluid control valve 20 in order to make such a configuration change to the fluid control valve 20.

As shown in FIG. 3, an alternative embodiment of the invention includes a yoke 140. For ease of reference, the reference numerals for portions of the yoke 140 of FIG. 3 are simply increased by a factor of 100 as compared to the reference numerals for corresponding portions of the yoke 40 depicted in FIG. 2. The yoke 140 differs from the yoke 40 of FIG. 2 primarily in that the yoke 140 includes a through passage 162 instead of the T-shaped air passage 62 of the yoke 40, and further includes a L-shaped air passage 182 instead of the T-shaped air passage 82 of the yoke 40. The through passage 162 connects a front instrument port 164 to a rear instrument port 166 on the first leg 154 of the yoke 140. The L-shaped passage 182 connects a front instrument port 184 to an actuator port 188 in the second leg 156 of the yoke 140. It should be noted that the ports 164, 166, 184, and 188 may all include internal threads to simplify connecting and plugging each of the ports 164, 166, 184, and 188, as desired.

For use in a situation where air supply is introduced below the diaphragm 44 of the fluid control valve 20 without accessories, the yoke 140 may be configured as follows. Air may be channeled directly from the back of an instrument into the second yoke leg 156 through the instrument port 184 and may enter the actuator housing 42 through the actuator port 188. In such a case the through passage 162 is not used and the ports 164 and 166 may be either plugged or left open. In such a configuration, the actuator housing 42 may be vented on its upper side to relieve pressure out as the instrument inputs air below the diaphragm 44.

For a configuration where air supply is provided below the diaphragm 44 with accessories, air may be channeled directly fro the back of an instrument into the first leg 154 through a rear instrument port 166, and one or more accessories may be connected to the front instrument port 164 and taken from the accessory back into the yoke 140 through the front instrument port 184 on the second leg 156. Air may now enter the actuator housing 42 via the actuator port 188, and as noted above, actuator housing 42 may be vented at its upper side to relieve pressure out as the instrument inputs air below the diaphragm 44.

In a configuration in which air is supplied above the diaphragm 44 without accessories, the air may be channeled directly from the back of an instrument into the first leg 154 through the rear instrument port 166 and tubing may be used to connect the front instrument port 164 to an upper portion of the actuator housing 42. The lower portion of the actuator housing 42 may then be configured to vent through the actuator port 188 to the front instrument port 184 of the second leg 156 of the yoke 140.

In a configuration in which air is supplied above the diaphragm 44 with the use of accessories, the accessory may be placed in line between the front instrument port 164 and the connection to the actuator housing 42.

One advantage of the alternative yoke 140 of FIG. 3 is that is eliminates the need for multiple pipe plugs which may be necessary in connection with the use of the yoke 40 of FIG. 2. In addition, it provides flexibility for connecting an instrument to the fluid control valve 20. For example, an instrument connected to the front instrument port 184 may be moved to the opposite side of the yoke 140 and connected to the rear instrument port 166, and tubing can be used to connect the front instrument port 164 to the front instrument port 184 in the second leg 156 of the yoke 140, to complete the connection between the instrument and the actuator housing 42.

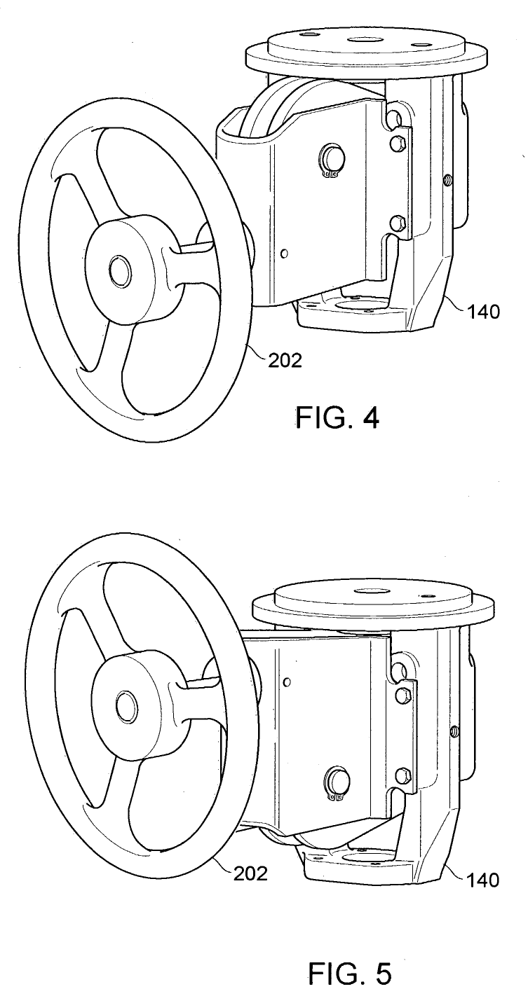

As shown in FIGS. 4 and 5, the yoke 140 may be used for mounting a side mounted hand wheel 202 in either a fail open configuration (FIG. 4) or in a fail closed configuration (FIG. 5).

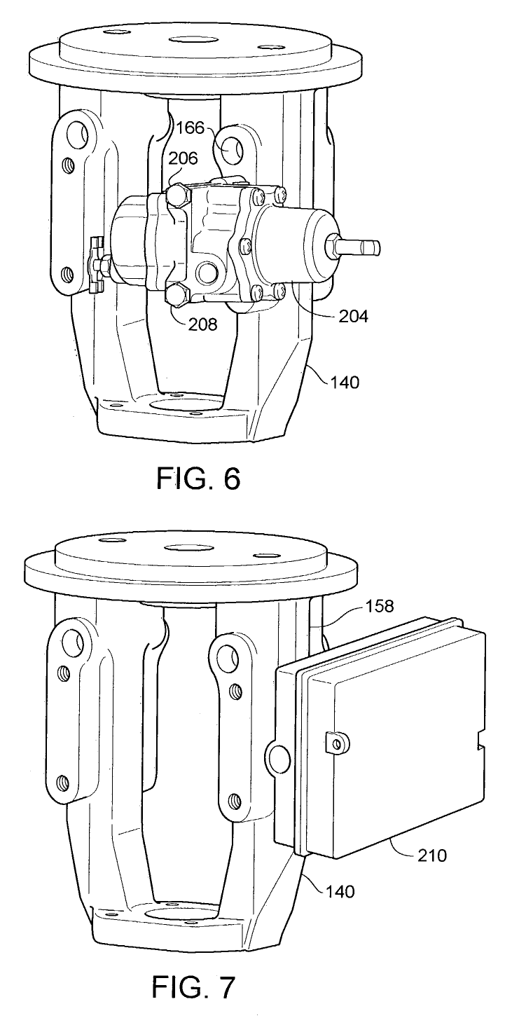

In addition, as depicted in FIG. 6 a pressure regulator 204 may be mounted to the yoke 140 at the blind bores 176, 178 (FIG. 3) using bolts 206 and 208.

As depicted in FIG. 7, the yoke 140 may be used to mount an old NAMUR instrument 210 using the rib 158 and the tapped bore 160 (FIG. 3).

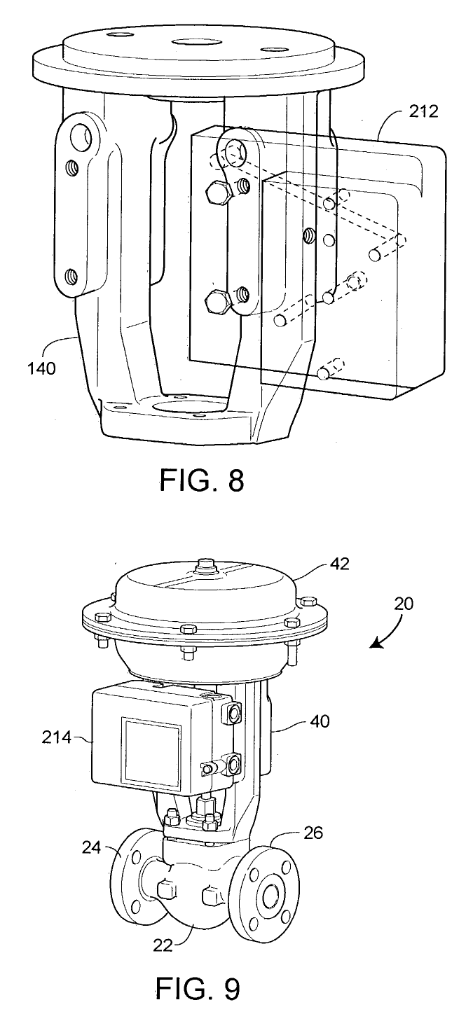

As depicted in FIG. 8, an adaptor block 212 may be used to provide a new NAMUR interface to the yoke 140 or to the yoke 40, if desired. The adapter block 212 connects the yoke 40 or the yoke 140 to a new NAMUR standard mounting pad.

As depicted in FIG. 9, an instrument 214 may be securely mounted to the yoke 40 using two or more of the tapped blind bores 170, 172, 190, and 192 (all of which are visible in FIG. 3).

As will be recognized by one skilled in the art, the yokes 40 and 140 in accordance with the invention provide a common “footprint” for mounting instruments to the fluid control valve 20, and may be used across product lines regardless of valve size. This permits a decrease in number of components necessary and decreased complexity to provide additional reliability, and reduced component cost.

While certain preferred embodiments have been described, it is recognized that variations may be made thereto that are still within the scope of the appended claims. For example, the yokes 40 and 140 may be used to provide an air supply to an actuator for a fluid control valve without the use of an instrument.

We claim:

1. A yoke member for a control valve having a movable member and an actuator operatively connected to the movable member, the yoke member comprising:
a plurality of air passages for connecting an air supply line to the actuator; and
a plurality of bores for directly attaching a control instrument to the yoke member.

2. The yoke member of claim 1, further including at least one air passage for connecting a valve accessory to the control valve.

3. The yoke member of claim 1, wherein the yoke member is symmetric.

4. The yoke member of claim 1, wherein the yoke member includes a first leg and a second leg.

5. The yoke member of claim 4, wherein the first leg and the second leg each include a T-shaped air passage.

6. The yoke member of claim 4, wherein one of the first leg and the second leg includes an L-shaped air passage.

7. The yoke member of claim 4, wherein at least one of the first leg and the second leg includes a rib compatible with the mounting surface of an old NAMUR standard instrument.

8. The yoke member of claim 4, wherein at least one of the air passages connects ports disposed on opposite sides of one of the first leg and the second leg.

9. A fluid control valve comprising:
a movable member;
an actuator operatively connected to the movable member; and
a yoke member including a plurality of air passages for connecting an air supply line from a control instrument associated with the actuator to the actuator; and
a plurality of bores for directly attaching the control instrument to the yoke member.

10. The fluid control valve of claim 9, further including an adapter block for connecting at least one of the air passages to a NAMUR standard mounting pad.

11. A yoke member for a control valve having a movable member and an actuator operatively connected to the movable member, the yoke member comprising:
a plurality of air passages for connecting an air supply line from a control instrument associated with the actuator to the actuator; and
a plurality of bores for directly attaching the control instrument to the yoke member.

12. The yoke member of claim 11, further including at least one air passage for connecting a valve accessory to the control valve.

13. The yoke member of claim 11, wherein the yoke member is symmetric.

14. The yoke member of claim 11, wherein the yoke member includes a first leg and a second leg.

15. The yoke member of claim 14, wherein the first leg and the second leg each include a T-shaped air passage.

16. The yoke member of claim 14, wherein one of the first leg and the second leg includes an L-shaped air passage.

17. The yoke member of claim 14, wherein at least one of the first leg and the second leg includes a rib compatible with the mounting surface of an old NAMUR standard instrument.

18. The yoke member of claim 14, wherein at least one of the air passages connects ports disposed on opposite sides of one of the first leg and the second leg.
